(19) United States
(12) Patent Application Publication
(10) Pub. No.: US 2012/0287075 A1
(43) Pub. Date: Nov. 15, 2012

(54) Active touch sensing circuit apparatus

(75) Inventors: Ya-Hsiang Tai, Hsinchu City (TW); Lu-Sheng Chou, Kaohsiung City (TW); Hao-Lin Chiu, Hsinchu City (TW)

(73) Assignee: National Chiao Tung University, Hsinchu City (TW)

(21) Appl. No.: 13/067,826

(22) Filed: Jun. 29, 2011

(30) Foreign Application Priority Data
May 12, 2011 (TW) 100116715

(51) Int. Cl. G06F 3/044; G06F 3/045

(52) U.S. Cl. 345/174

(57) ABSTRACT

The invention discloses an active matrix touch sensing circuit apparatus used in a touch panel comprises a sensing unit, a resistance, and a thin film transistor. The resistance connects the sensing unit and the first scan line. The control end of the thin film transistor connects the sensing unit, the second scan line connects the input end of the thin film transistor, and the read out line connects the output end of the thin film transistor. When the sensing value of the body touch sensing unit is changed, and then the input wave form of the control end is changed. The output end generates an open current, and the read out line transmits the open current.

### BACKGROUND OF THE INVENTION

1. Field of the Invention

The invention relates to a sensing circuit apparatus, particularly to an active touch sensing circuit apparatus.

2. Description of the Prior Art

The application range of touch panel is very wide, including portable information, consumer and communication products, finance or commercial use, factory automatic control system, public information use etc. In addition, since every large electronic factory introduces the hot touch action apparatus, such as the smart cell phone, tablet computer etc., the users realize the application convenience touch products again. Meantime, it also generates another change on conventional operation practice, the more convenient touch solution is started to be introduced into the consumer products, in order to replace relatively aged, failed, or corroded mechanical switch. The flat layout of apparatus is able to be integrated with the design of most electronic apparatuses very easily, thus the demand of touch panel is increased greatly.

In addition, the detection of surface capacitance change is often used as the basic operation principle of touch sensing unit, wherein the sensation of positioning and pressing action is carried at the contact point. When the part or finger of human body touches the metal sheet of sensing unit, a small change of capacitance value will be caused on the metal sheet immediately. When the conductive part is moved on the metal sheet, the electric field of metal sheet will be changed at the same time, and then the capacitance value will be changed. The touch sensing unit collects these small changes, deals with the coordinate of feedback contact point and the action form, which are the basic touch sensing the mechanisms. The touch sensing circuit is one of main components in the touch panel. It is used to sense the contact position of body, so that the control system is able to know the actual contact position of body on the panel in order to control the apparatus correctly.

As shown in Patent No. 100405146C of the People Republic of China, a touch liquid crystal display is disclosed. Please refer to FIG. 1 and FIG. 2, wherein FIG. 1 illustrates the schematic diagram of liquid crystal display, and the FIG. 2 illustrates partial circuit diagram for the liquid crystal display of FIG. 1.

The liquid crystal display 100 of FIG. 1 includes a gate driver 102, a source driver 104, a constant voltage unit 106, a judging unit 108 and a liquid crystal display panel 110. The liquid crystal display panel 110 of FIG. 1 includes a plurality of pixel unit 200 and a plurality of sensing circuit 210 shown in FIG. 2.

As shown in FIG. 2, every sensing circuit 210 is connected to the pixel unit 200. It has to pay special attention that the number of sensing circuit 210 in FIG. 2 may be less than or equal to the number of pixel unit 200. The plurality of sensing circuits 210 in FIG. 2 are distributed evenly on the liquid crystal display panel 110 of FIG. 1. Every pixel unit 200 in FIG. 2 includes a switch transistor 202, a storing capacitance 204 and a liquid crystal capacitance 206. The liquid crystal capacitance 206 is made up of two electrodes. One electrode is connected to the common voltage V_{com}, and another electrode is connected to the switch transistor 202. The liquid crystal molecules are distributed between two electrodes. When the switch transistor 202 receives the scanning signal of scan line G_{N-1} generated from the gate driver 102 in FIG. 1, the information signal voltage generated from the source driver 104 in FIG. 1 will be transmitted to the liquid crystal capacitance 206 in FIG. 2 through the information line Dₙ.

The liquid crystal molecules of liquid crystal capacitance 206 in FIG. 2 control the light intensity passing through the liquid crystal molecules in accordance with different arrangement direction of voltage difference between the common voltage V_{com} and information signal voltage. The storing capacitance 204 in FIG. 2 is used to store the information signal voltage, so that the voltage difference between the common voltage and information signal voltage can be maintained by the liquid crystal capacitance 206 when the switch capacitance 202 in FIG. 2 is shut, thus the light intensity passing through the liquid crystal molecules can be kept constant. The sensing circuit 210 in FIG. 2 includes a first transistor 211, a second transistor 212, a third transistor 213 and a sensing unit. The sensing unit is used to generate a dynamic voltage at node Y during a specific period. Thus in this embodiment, the sensing unit might be a touch capacitance Cᵥ. As for its principle, the touch capacitance Cᵥ will output a dynamic voltage to node Y in accordance with the dynamic change of capacitance value of touch capacitance Cᵥ during the specific period.

However, the above-mentioned conventional touch liquid crystal display should use an extra gate electrode to control and drive the scan lines G₁-G_{N}, which would increase the extra cost. The voltage is used as the response signal, and the source electrode of sensing circuit is used to read the voltage value, which is apt to sound by the variation among the components. This case utilizes the partial voltage concept of capacitance for sensing. Thus, its response signal is weaker and hard to be read. Finally, when it is not touched, there is still big current that is passed, thus the power consumption is very large, and it will be unfavorable for the use of touch panel with large area.

From the above-mentioned description, the touch sensing circuit of conventional touch panel is unable to achieve a the required demand, thus it is necessary to invent a touch sensing circuit with high sensing signal intensity, in order to produce high sensing signal intensity and reduce the cost of read circuit.

### SUMMARY OF THE INVENTION

The purpose of the invention is for providing an active touch sensing circuit with a controllable gate voltage close time, which can be used in the in-cell or the on-cell touch panel. When the capacitance is touched, its capacitance value will be changed at the same time, so that as serious RC delay effect will be generated for the wave form of the gate electrode of transistor. The drain electrode of transistor will output a larger open current, make the open current is easy to be read, raise the intensity of sensing signal, and reduce the wrong judgment rate.

The invention discloses an active matrix touch sensing circuit apparatus used in a touch panel includes a sensing unit, a resistance, and a thin film transistor. The first end of sensing unit connects the prescribed constant voltage. The first end of resistance connects the second end of sensing unit, and the second end of resistance connects the first scan line. The control end of the thin film transistor connects the second end of sensing unit, the second scan line connects the input end of the thin film transistor, and the read out line connects the output end of the thin film transistor. The sensing value of the sensing unit is changed, when the sensing unit senses a body touched the circuit, and wave form of the control end is changed. The output end generates an open current, and the read out line transmits the open current.

The sensing unit of the invention may be a variable capacitance, wherein when the body touches the variable capacitance, the capacitance value of the variable capacitance will be changed.

The resistance of the invention can be achieved by a thin film transistor, and when the capacitance value is changed, the corresponding wave form will be changed.

When the wave form is inputted in the invention, the wave form will be changed, because a RC delay is generated by the resistance and the variable capacitance.

The first scan line of the invention comprises a first signal. The first signal is changed from the high electric potential to the low electric potential. The second scan line includes a second signal. The second signal is changed from the low electric potential to the high electric potential. Wherein, there is the prescribed time interval between the first signal and the second signal.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates the schematic diagram of the conventional liquid crystal display;

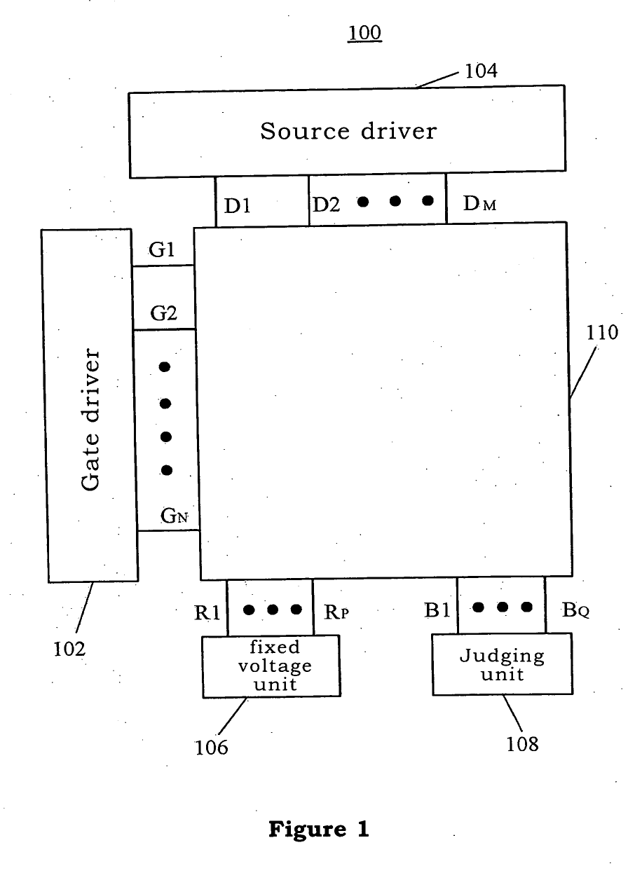

FIG. 2 illustrates partial circuit diagram for the conventional liquid crystal display of FIG. 1;

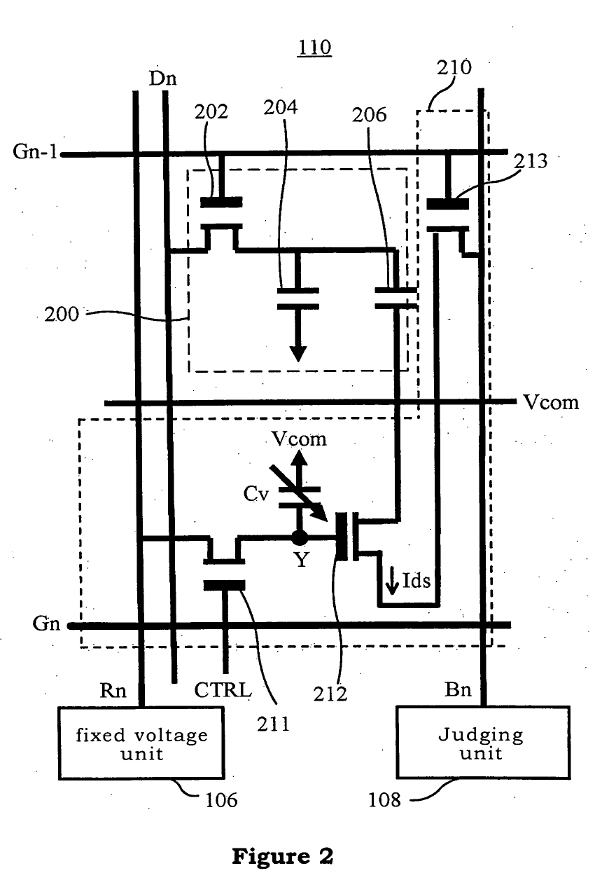

FIG. 3A illustrates the schematic diagram of the active touch sensing circuit for an embodiment of the invention;

FIG. 3B illustrates the schematic diagram for the active touch sensing circuit of FIG. 3A with the first scan line and the second scan line as well as the first signal and the second signal; and

FIG. 4 shows the measurement result of the active touch sensing circuit shown in FIG. 3A.

### DESCRIPTION OF THE PREFERRED EMBODIMENT

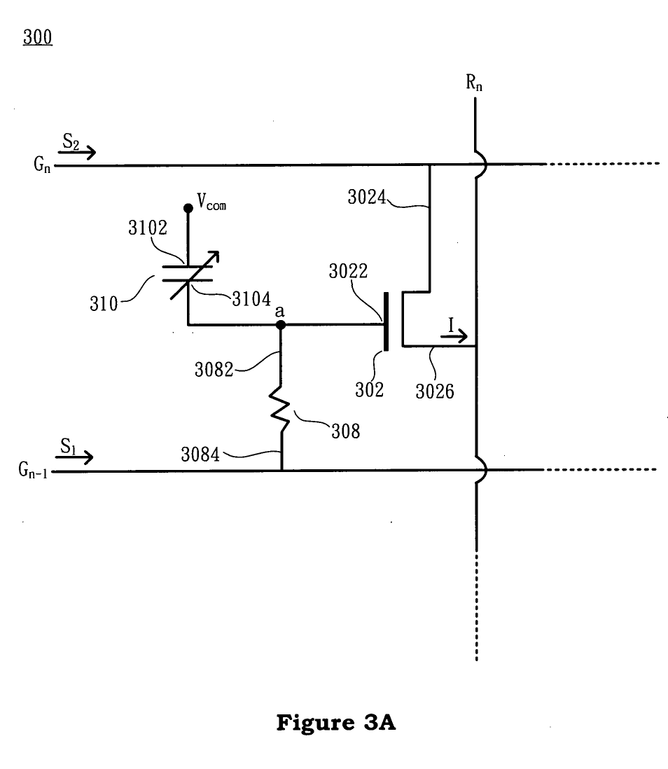

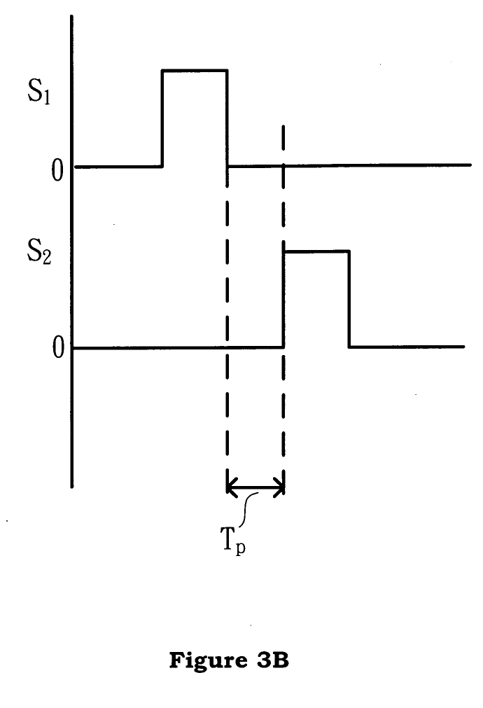

The invention relates to an active touch sensing circuit apparatus. Please refer to FIG. 3A, FIG. 3A illustrates the schematic diagram of the active touch sensing circuit for an embodiment of the invention. In FIG. 3A, the active touch sensing circuit apparatus 300 can be used in the touch sensing component of a sensing panel (not shown in the figure), which is used to sense the position of touch panel touched by the users. The users may touch the touch display apparatus directly, such as the smart cell phone, tablet computer etc., in order to control the apparatus.

Please refer to FIG. 3A again, the active touch sensing circuit apparatus 300 comprises a sensing unit 310, a resistance (known as thin film transistor) 308, and a transistor 302. The sensing unit 310 has a first end 3102 and a second end 3104. The first end 3102 of sensing unit 310 connects a prescribed constant voltage V_{com}. The resistance 308 has a first end 3082 and a second end 3084. Only an active touch sensing circuit apparatus 300 is disclosed in the embodiment. However, it is known that the touch sensing component of a sensing panel (not shown in the figure) may include a plurality of the above-mentioned active touch sensing circuit apparatus 300. In the embodiment, the transistor 302 may be the thin film transistor (TFT). However, the transistor 302 of this case may be replaced by various thin film transistors.

In FIG. 3A, the first end 3082 of resistance 308 connects the second end 3104 of sensing unit 310, and the second end 3084 of resistance 308 connects the first scan line G_{N-1}. The transistor 302 has a control end 3022, an input end 3024, and an output end 3026. The control end 3022 of transistor 302 connects the second end 3104 of sensing unit 310. The second scan line 3024 connects the input end of the transistor 302. The read out line R_{N} connects the output end 3026 of the transistor 302. The read out line R_{N} is used to read a current signal outputted by the output end 3026. The resistance of this embodiment is not limited by common resistance component. It may be achieved by other component, such a thin film transistor.

Please refer to FIG. 3A continuously, the first scan line G_{N-1} further comprises a first signal S₁. The second scan line G_{N} further comprises a second signal S2. The first signal S₁ is changed from the high electric potential to the low electric potential. The second signal S2 is changed from the low electric potential to the high electric potential. Wherein, there is prescribed time interval Tₚ between the first signal S₁ and the second signal S2. As shown in FIG. 3B, it is used to adjust and assure no parasitical capacitance effect, so that the current flows out with no contact.

In this embodiment, when the finger of user touches the active touch sensing circuit apparatus 300 installed in the touch panel (not shown in the figure), the sensing value of the sensing unit 310 is changed, and the input wave form of control end 3022 of transistor 302 is changed. The output end 3026 generates an open current I, and the read out line R_{N} transmits the open current I. Wherein, the wave form will be changed, because a RC delay is produced by the resistance and the variable capacitance.

In another embodiment, the sensing unit 302 of the active touch sensing circuit apparatus 300 is a variable capacitance. When the finger of user touches the variable capacitance, the capacitance value of the variable capacitance is changed. In addition, when the capacitance value is changed, the corresponding wave form will be changed. The input wave form received by the control end 3022 of transistor 302 will also be changed. Finally, the output end 3026 generates an open current I, and the read out line R_{N} transmits the open current I.

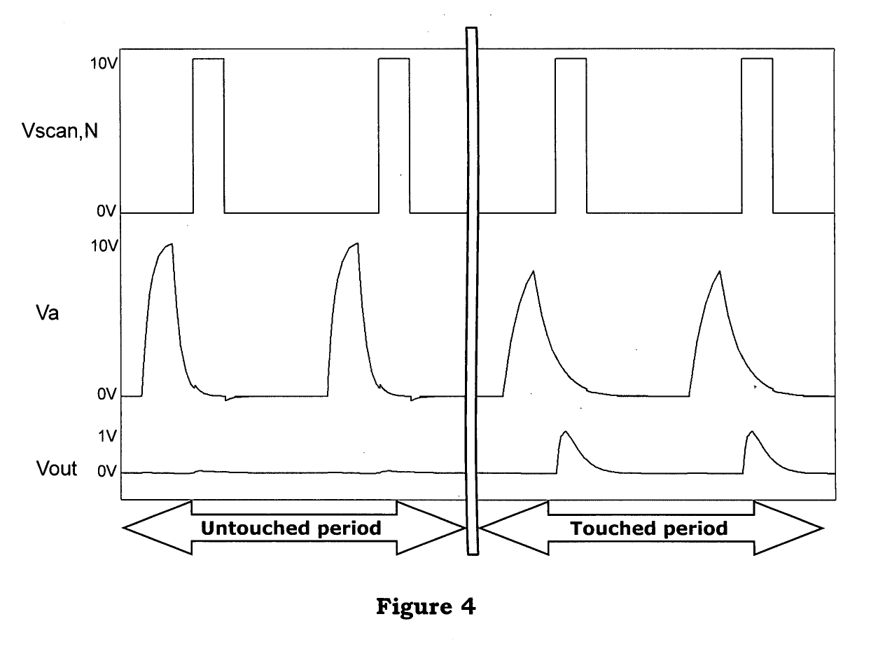

Please refer to FIG. 3A and FIG. 4, wherein FIG. 4 shows the measurement result of the active touch sensing circuit shown in FIG. 3A. The control end 3022 (gate electrode) of transistor 302 connects the sensing unit 310 and the resistance 308 in order to form a RC low-pass filter. The voltage applied on the Node a is the wave form passing through this low-pass filter, as the wave form Vₐ shown in FIG. 4. The wave form Vₐ connects the control end 3022 of transistor 302. The electric potential of the second scan line G_{N} is V_{scan,N}. When the active touch sensing circuit apparatus 300 is untouched, and the electric potential V_{scan,N} in the second scan line G_{N} is switched to high electric potential, the electric potential Va in Node a is switched from the high electric potential to the low electric potential, so that the transistor can be kept in close state (low current).

As shown in FIG. 4, When the active touch sensing circuit apparatus 300 is touched, the electric potential in Node a is influenced by the resistance and capacitance. The time for switching to the low electric potential will be delayed, so that the transistor is kept in close state (low current). Thus, when the electric potential V_{scan,N} in the second scan line G_{N} is switched to the high electric potential, an open current I will be generated simultaneously. The open current I will be transmitted and read by the read out line R_{N}.

In this embodiment of the invention, the large current will be generated only upon touching. There is no current generated upon untouched. It can make the whole circuit consume lower power. The large open current I will be used the response signal of the active touch sensing circuit apparatus 300. Thus the influence of component variation can be reduced greatly. The read of simultaneous large current is very low for the design demand of the integrated circuit. Thus the circuit cost can be reduced, and it can also be used in the touch panel with large area.

It is understood that various other modifications will be apparent to and can be readily made by those skilled in the art without departing from the scope and spirit of this invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled in the art to which this invention pertains.

What is claimed is:

1. An active matrix touch sensing circuit apparatus used in a touch panel, comprising:
a sensing unit, a first end of the sensing unit connecting a prescribed constant voltage;
a resistance, a first end of the resistance connecting a second end of the sensing unit, and the second end of the resistance connecting a first scan line; and
a transistor, a control end of the transistor connecting a second end of the sensing unit, a second scan line connecting a input end of the transistor, and a read out line connecting an output end of the transistor; wherein, a sensing value of the sensing unit being changed after a body touching the sensing unit, an input wave form of the control end being changed, so that the output end generating an open current, the read out line transmitting the open current.

2. The apparatus according to claim 1, wherein the sensing unit comprises a variable capacitance, wherein when the body touching the variable capacitance, the capacitance value of the variable capacitance is changed.

3. The apparatus according to claim 2, wherein, when the capacitance value is changed, the corresponding wave form is changed.

4. The apparatus according to claim 2, wherein the wave form is changed due to a RC delay is generated by the resistance and the variable capacitance.

5. The apparatus according to claim 2, wherein the first scan line further comprising a first signal, the first signal is changed from a high electric potential to a low electric potential, the second scan line further comprising a second signal, the second signal is changed from a low electric potential to a high electric potential, wherein, there is a prescribed time interval between the first signal and the second signal.

6. The apparatus according to claim 2, wherein the transistor comprises a thin film transistor.

7. The apparatus according to claim 1, wherein the transistor comprises a thin film transistor.
